(19) United States
(12) Patent Application Publication
(10) Pub. No.: US 2026/0223136 A1
(43) Pub. Date: Jul. 30, 2026

(54) SIDELINK COMMUNICATION METHODS AND DEVICES

(71) Applicant: Sony Group Corporation, Tokyo (JP)

(72) Inventors: Vivek SHARMA, Surrey (GB); Yuxin WEI, Basingstoke (GB); Yassin Aden AWAD, Uxbridge (GB); Hideji WAKABAYASHI, Hampshire (GB)

(73) Assignee: Sony Group Corporation, Tokyo (JP)

(21) Appl. No.: 19/145,515

(22) PCT Filed: Jan. 17, 2024
(86) PCT No.: PCT/EP2024/051037

§ 371 Date: Jul. 3, 2025

(30) Foreign Application Priority Data
Jan. 24, 2023 (EP) 23153100.5

(51) Int. Cl. H04W 72/25; H04W 56/00

(52) U.S. Cl. CPC H04W 72/25; H04W 56/006

(57) ABSTRACT

A method of operating a first sidelink communications device synchronised in time with a timing source is provided. The method comprises transmitting timing information to a second sidelink communications device via a sidelink interface. The timing information comprises f either a referenced time or a non-referenced time. The referenced time is an absolute time at the first sidelink communications device. The non-referenced time is the absolute time at the first sidelink communications device adjusted for propagation delay between the first sidelink communications device and the second sidelink communications device.

### BACKGROUND

### Field

The present disclosure relates to sidelink communications devices and methods of operating sidelink communications devices.

The present application claims the Paris Convention priority from EP patent application number EP23153100.5, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems. Furthermore, high reliability and availability communications services such as time sensitive communications (TSC)/time sensitive networking (TSN) have been provided. However, there is a need for improved support for TSC and TSN in wireless communications networks.

### SUMMARY

The present disclosure can help address or mitigate at least some of the issues discussed above.

Example embodiments can provide a method of operating a first sidelink communications device synchronised in time with a timing source. The method comprises transmitting timing information to a second sidelink communications device via a sidelink interface. The timing information comprises either a referenced time or a non-referenced time. The referenced time is an absolute time at the first sidelink communications device. The non-referenced time is the absolute time at the first sidelink communications device adjusted for propagation delay between the first sidelink communications device and the second sidelink communications device.

Example embodiments can provide a method of operating a first sidelink communications device synchronised in time with a timing source. The method comprises transmitting a first measurement message to a second sidelink communications device via a sidelink interface. The method comprises receiving a second measurement message from the second sidelink communications device via the sidelink interface. The method comprises determining a time difference between a time, T1, at which the first measurement message is transmitted to the second sidelink communications device and a time, T4, at which the second measurement message is received by the first sidelink communications device. The method comprises determining a time difference between a time, T2, at which the second sidelink communications device receives the first measurement message and a time, T3, at which the second sidelink communications device transmits the second measurement message. The time difference between T2 and T3 is either pre-configured or the second measurement message comprises information for determining the time difference between T2 and T3. The method comprises determining a propagation delay between the first sidelink communications device and the second sidelink communications device based the time difference between T1 and T4 and the time difference between T2 and T3.

Example embodiments can provide a method of operating a second sidelink communications device. The method comprises receiving a first signal via a first sidelink interface from a first sidelink communications device synchronised in time with a timing source. The method comprises transmitting a second signal to a third sidelink communications device via a second sidelink interface. The method comprises receiving, from the third sidelink communications device via the second sidelink interface, a third signal. The first, second and third signals are different from each other. The method comprises determining a time difference between a time of arrival of the first signal from the first sidelink communications device and a time of arrival of the third signal from the third sidelink communications device at the second sidelink communications device. The method comprises receiving, from the third sidelink communications device via the second sidelink interface, information for determining a time difference between a time of arrival of the first signal and a time of arrival of the second signal at the third sidelink communications device. The method comprises determining the time difference between the time of arrival of the first signal and the time of arrival of the second signal at the third sidelink communications device based on the information received from the third sidelink communications device. The method comprises determining a propagation delay between the second sidelink communications device and the third sidelink communications device based on the time difference between the time of arrival of the first signal and the third signal at the second sidelink communications device and the time difference between the time of arrival of the first signal and the second signal at the third sidelink communications device.

Example embodiments can provide a method of operating a second sidelink communications device. The method comprises receiving Time Sensitive Communication Assistance Information, TSCAI, from a first sidelink communications device via a sidelink interface The TSCAI information comprises one or more of a burst timing, periodicity and survival time. The method comprises performing resource allocation based on the received TSCAI.

As will be appreciated from an understanding of the following detailed description, example embodiments can provide support for Time Sensitive Networking over sidelink.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (NR) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of a UE-side RTT-based PDC signalling procedure;

FIG. 5 schematically illustrates an example of a gNB-side RTT based PDC signalling procedure;

FIG. 6 schematically illustrates a wireless communications network comprising a plurality of sidelink communications devices in accordance with example embodiments;

FIG. 7 schematically illustrates the transmission of timing information between sidelink communications devices in accordance with example embodiments;

FIG. 8 schematically illustrates the reservation of resources for transmitting timing information in accordance with example embodiments;

FIG. 9 schematically illustrates an example of sidelink propagation delay measurement using reciprocal messages in accordance with example embodiments;

FIG. 10 schematically illustrates an example of sidelink propagation delay measurement using HARQ feedback in accordance with example embodiments;

FIG. 11 schematically illustrates an example of sidelink propagation delay measurement using S-SSBs in accordance with example embodiments;

FIG. 12 schematically illustrates S-SSB transmission between sidelink communications devices for determining propagation delay in accordance with example embodiments;

FIG. 13 schematically illustrates S-SSB transmission between sidelink communications devices for determining propagation delay in accordance with example embodiments; and

FIG. 14 schematically illustrates the transmission of TSCAI in accordance with example embodiments.

### DETAILED DESCRIPTION OF THE EMBODIMENTS

### Long Term Evolution Advanced Radio Access Technology (4G)

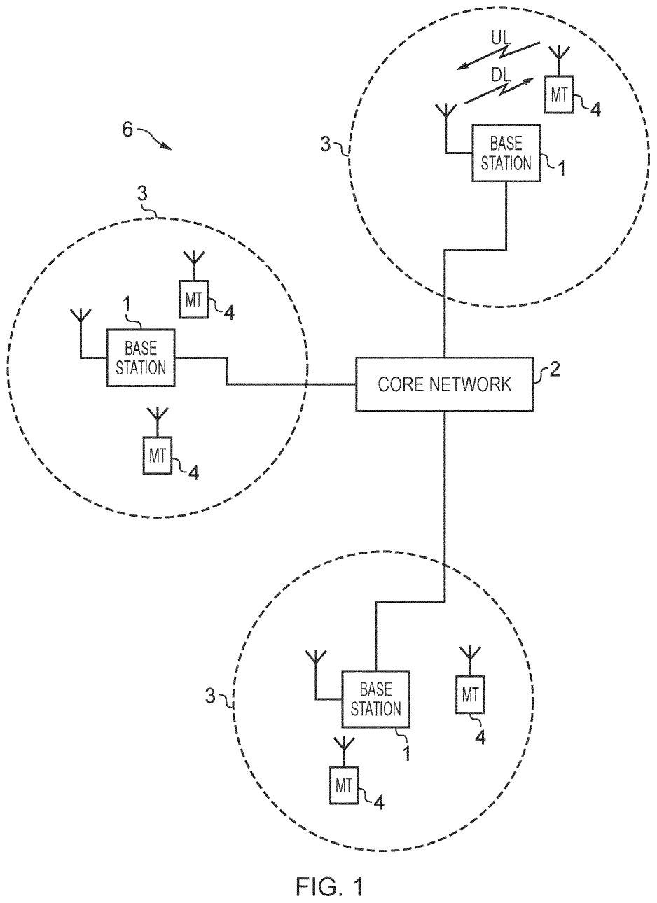

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Communications devices may also be referred to as mobile stations, user equipment (UEs), user terminals, mobile radios, terminal devices, wireless transmit and receive units (WTRUs), and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIOT) in order to support services with new requirements of high availability, high reliability, low latency, and in some cases, high-accuracy positioning.

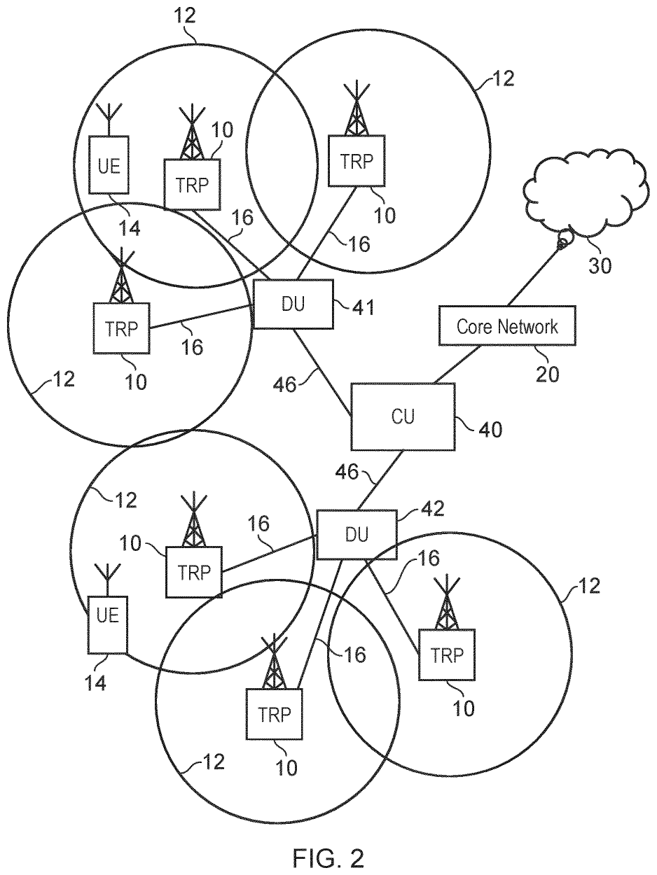

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

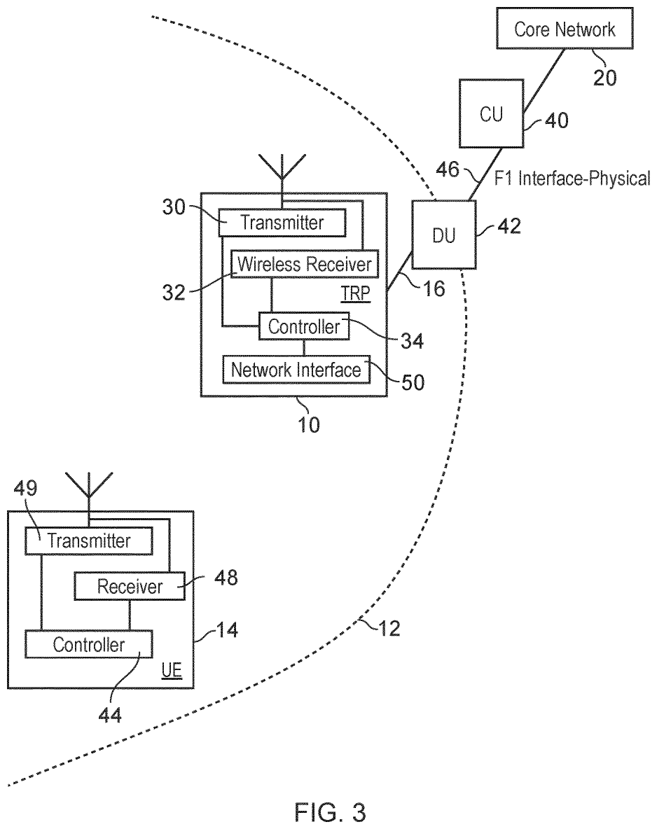

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 [3] and 3GPP TS 38.473 [4], and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Time Sensitive Communications

Time Sensitive Communications (TSC), as defined in TS 23.501, is a communication service that supports deterministic communication and/or isochronous communication with high reliability and availability. Examples of such services are the services provided in the Industrial Internet of Things, e.g., related to cyber-physical control applications as described in TS 22.104.

### Timing Information

To support strict synchronisation accuracy requirements of TSC applications, a gNB of a wireless communications network transmits timing information to a UE. The timing information may be transmitted using unicast or broadcast signalling (e.g. RRC signalling). The timing information is used by the UE to synchronise with a timing source. The timing source may be the gNB, or another entity in the wireless communications network which maintains an accurate and stable clock. For example, the UE may synchronise with the gNB when it is in coverage of the gNB. For example, UE1 402 may synchronise with the gNB by receiving one or more synchronisation signals (such as PSS/SSS) from the gNB. The gNB or other entity in the wireless communications network may already be synchronised with a Precision Time Protocol (PTP/gPTP-GM) or Time Sensitive Network-Grand Master (TSN-GM) Clock or a 5G Grand Master (5GM) System. Examples of a TSN-GM clock or 5G GM system include Global Navigation Satellite System (GNSS) clock, an atomic clock, Global Positioning System (GPS) time, or Coordinated Universal Time. In some cases, such as when the UE is out of coverage, the UE may synchronise directly with GNSS, an atomic clock, GPS time, or Coordinated Universal Time.

The time indicated by the timing information may be a “referenced time” or a “non-referenced time”. The referenced time is an absolute time at the gNB. The non-referenced time is the absolute time at the gNB adjusted for propagation delay between the gNB and the UE. For example, the gNB may pre-compensate for radio-frequency propagation delay.

An uncertainty parameter may be included in timing information to indicate the accuracy of the timing information. The UE may indicate to the gNB a preference to be provisioned with timing information using a UE Assistance Information procedure.

Typically, timing information is transmitted in SIB9 over a Uu interface between the gNB and UE (TS 38.331). The “ReferenceTimeInfo” information element in the SIB9 indicates the timing information. The “ReferenceTimeInfo” information element is alternatively referred to as the “Reference TimeInfo” field.

The field descriptions of the ReferenceTimeInfo information element are shown in Table 1 which has been reduced from TS 38.331.

TABLE 1
ReferenceTimeInfo Field Descriptions
ReferenceTimeInfo field descriptions
referenceSFN
This field indicates the reference SFN corresponding to the reference time information. If referenceTimeInfo field is
received in DLInformationTransfer message, this field indicates the SFN of PCell.
time
This field indicates time reference with 10 ns granularity. The indicated time is referenced at the network, i.e., without
compensating for RF propagation delay. The indicated time in 10 ns unit from the origin is
refDays*86400*1000*100000 + refSeconds*1000*100000 + refMilliSeconds*100000 + refTenNanoSeconds. The
refDays field specifies the sequential number of days (with day count starting at 0) from the origin of the time field. If
the referenceTimeInfo field is received in DLInformation Transfer message, the time field indicates the time at the
ending boundary of the system frame indicated by referenceSFN. The UE considers this frame (indicated by
referenceSFN) to be the frame which is nearest to the frame where the message is received (which can be either in the
past or in the future). If the referenceTimeInfo field is received in SIB9, the time field indicates the time at the SFN
boundary at or immediately after the ending boundary of the SI-window in which SIB9 is transmitted. If
reference TimeInfo field is received in SIB9, this field is excluded when determining changes in system information,
i.e. changes of time should neither result in system information change notifications nor in a modification of
valueTag in SIB1.
timeInfoType
If timeInfoType is not included, the time indicates the GPS time and the origin of the time field is 00:00:00 on
Gregorian calendar date 6 Jan., 1980 (start of GPS time). If timeInfoType is set to localClock, the origin of the
time is unspecified.
uncertainty
This field indicates the uncertainty of the reference time information provided by the time field. The uncertainty is
25 ns multiplied by this field. If this field is absent, the uncertainty is unspecified.

| Conditional | |
|---|---|
| Presence | Explanation |
| RefTime | The field is mandatory present if referenceTimeInfo is included in DLInformationTransfer |
| | message; otherwise the field is absent. |

### Propagation Delay Compensation

Propagation delay compensation (PDC) mechanisms may be applied based on Round Trip Time (RTT) or Timing Advance (TA), and can be performed at the UE or gNB side. When performed at UE side, the PDC mechanisms are controlled via RRC signalling by the gNB.

The RTT-based PDC mechanism is achieved by using Rx-Tx time difference measurements of a single pair of configured Tracking Reference Signal (TRS)/Positioning Reference Signal (PRS) and Sounding Reference Signal (SRS).

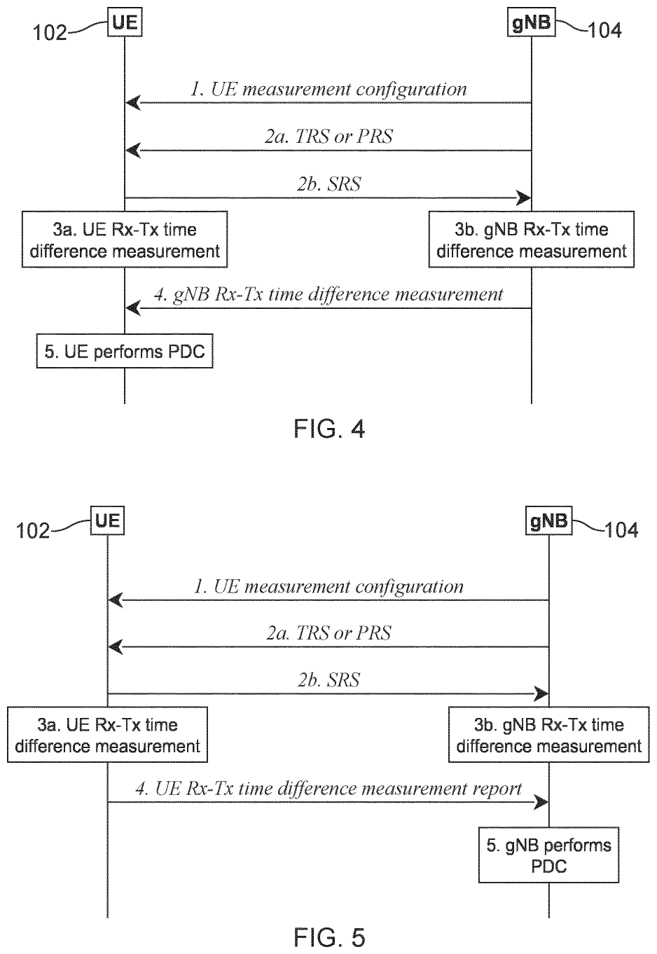

An example of signalling procedures in a UE-side RTT-based PDC is shown in FIG. 4. In step 1, a gNB 104 provides measurement configurations to a UE 102. In step 2a, the gNB 104 transmits TRS or PRS to the UE 102 for measurements. In step 2b, the UE 102 transmits SRS to the gNB 104 for measurement. In steps 3a and 3b, both the UE 102 and the gNB 104 perform Rx-Tx time difference measurements. In step 5, the UE 102 performs PDC based on Rx-Tx time difference measurements from itself and the gNB 104.

An example of signalling procedures in a gNB-side RTT based PDC is shown in FIG. 5. In step 1, the gNB 104 provides measurement configurations to the UE 102. In step 2a, the gNB 104 transmits TRS or PRS to the UE 102 for measurements. In step 2b, the UE 102 transmits SRS to the gNB 104 for measurement. In steps 3a and 3b, both the UE 102 and the gNB 104 perform Rx-Tx time difference measurements. In step 4, the UE 102 reports its Rx-Tx time difference measurement to the gNB 104. In step 5, the gNB 104 performs PDC based on Rx-Tx time difference measurements from itself and the UE 102.

The gNB 104 may also receive TSC Assistance Information (TSCAI) from the Core Network, e.g., during QoS flow establishment, or from another gNB 104 during handover. TSCAI contains additional information about the traffic flow such as burst arrival time, burst periodicity, and survival time. TSCAI is discussed further in TS 23.501. TSCAI knowledge may be leveraged in the gNB's scheduler to more efficiently schedule periodic, deterministic traffic flows either via Configured Grants, Semi-Persistent Scheduling or with dynamic grants, and/or to improve the associated link reliability to meet the survival time requirement (see TS 22.104).

To support uplink periodic traffics of services with a survival time requirement, configured grant resources can be used such that the mapping relation between the service and the configured grant is known to both gNB 104 and UE 102, thus allowing the gNB 104 to use configured grant retransmission scheduling (addressed by Configured Scheduling Radio Network Terminal Identifier (CS-RNTI) to trigger survival time state entry for the corresponding data radio bearer (DRB). Upon survival time state entry, all Radio Link Control (RLC) entities configured for the DRB are activated by the UE 102 for duplication to prevent failure of subsequent messages and hence fulfilling the survival time requirement. If Carrier Aggregation (CA) or Dual Connectivity (DC) duplication for the DRB is already activated, the DRB should enter survival time state when any retransmission grant for any of its active Logical Channels (LCHs) is received.

In some cases, a gNB determines the propagation delay between itself and a UE by using random access channel (RACH) procedure. For example, a UE synchronises with a gNB by receiving a synchronization signal (PSS/SSS) from the gNB. Then, the UE sends a RACH preamble to the gNB. The gNB receives the RACH preamble and determines the time difference (rounds trip time) between transmitting the synchronisation signal and receiving the RACH preamble. The gNB determines the propagation delay as half of the round trip time.

### Sidelink Communication

As will be known to a person skilled in the art, sidelink communications refers to communications between communications devices over a sidelink interface (such as a PC-5 interface). A communications device which can communicate with another communications device over a sidelink interface will be referred to herein as a “sidelink communications device”. Sidelink communications devices typically have both transmitter and receiver capabilities. Existing NR sidelink communication can support one of three types of transmission modes (see T38.300) for a pair of a Source Layer-2 ID and a Destination Layer-2 ID in the AS:
(1) Unicast transmission, characterized by:
Support of one PC5-RRC connection between peer UEs for the pair;
Transmission and reception of control information and user traffic between peer UEs in sidelink;
Support of sidelink HARQ feedback;
Support of sidelink transmit power control;
Support of RLC AM;
Detection of radio link failure for the PC5-RRC connection.
(2) Groupcast transmission, characterized by:
Transmission and reception of user traffic among UEs belonging to a group in sidelink;
Support of sidelink HARQ feedback.
(3) Broadcast transmission, characterized by:
Transmission and reception of user traffic among UEs in sidelink.

The function of the MAC layer in sidelink communications is priority handling between uplink and sidelink transmissions for a given UE. With LCP restrictions in MAC, only sidelink logical channels belonging to the same destination can be multiplexed into a MAC PDU for every unicast, groupcast and broadcast transmission which is associated to the destination.

For transmissions to receiving UE(s) using SL DRX operation, LCP ensures that a transmitting UE transmits data in the active time of the receiving UE(s).

When the UE cannot simultaneously perform both NR sidelink transmission and NR uplink transmission in time domain, prioritisation between both transmissions is done based on their priorities and thresholds configured by the NG-RAN or pre-configured. When the UE cannot simultaneously perform both V2X sidelink transmission and NR uplink transmission in time domain, prioritization between both transmissions is done based on the priorities (i.e., PPPP) of V2X sidelink communication and a threshold configured by the NG-RAN or pre-configured.

Currently, TSN for sidelink communications is not supported. For example, timing information is currently transmitted in SIB9 over the Uu interface. However, existing sidelink interfaces (such as PC-5) do not support the broadcast transmission of SIBs and therefore do not support the transmission of timing information. Additionally, procedures for PDC over a sidelink interface have not been defined.

There is therefore a need for methods and sidelink communications devices which can support TSN.

### Sidelink Timing Information

In view of the above technical challenges, example embodiments can provide a method of operating a first sidelink communications device synchronised in time with a timing source. The method comprises transmitting timing information to a second sidelink communications device via a sidelink interface. The timing information comprises either a referenced time or a non-referenced time. The referenced time is an absolute time at the first sidelink communications device. The non-referenced time is the absolute time at the first sidelink communications device adjusted for propagation delay between the first sidelink communications device and the second sidelink communications device.

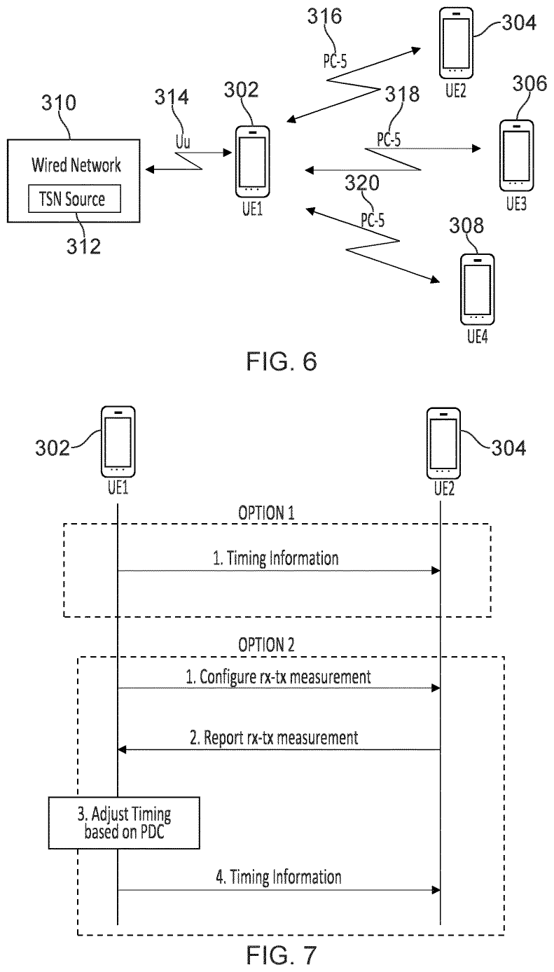

FIG. 6 illustrates a wireless communications network comprising a wired network 310 and a plurality of communications devices including a first sidelink communications device (UE1 302), a second sidelink communications device (UE2 304), a third sidelink communications device (UE3 306) and a fourth sidelink communications device (UE4 308). As shown in FIG. 6, UE1 302 is connected to the wired network 310 via a Uu 314 interface. In some embodiments, UE1 302 communicates directly with the wired network 310 without, for example, intervention of a gNB. In some embodiments, UE1 302 may communicate with the wired network 310 via a gNB (not shown in FIG. 6). As shown in FIG. 6, the wired network 310 comprises a timing source 322. The timing source 322 may be an entity in the wired network 310 which maintains an accurate and stable clock. In some embodiments, where UE1 302 communicates with the wired network 310 via a gNB, the gNB may comprise the timing source. UE1 302 synchronises with the timing source 312 using conventional synchronisation methods such as by receiving timing information as explained above. The timing information may be received from the wired network 310 directly or via the gNB. As will be understood by one skilled in the art, UE1 302 synchronising with the timing source means that a clock maintained by UE1 302 is adjusted to show the same time as the timing source. As shown in FIG. 6, there is a Uu interface 314 between UE1 302 and the wired network 310, a sidelink interface between UE1 302 and UE2 304 (PC-5 316), a sidelink interface between UE1 302 and UE3 306 (PC-5 318) and a sidelink interface between UE1 302 and UE4 308 (PC-5 320).

In accordance with example embodiments, UE1 302 may transmit timing information to one or more of UE2 304, UE3 306 and UE4 308. In some embodiments, the timing information may be transmitted as a unicast transmission. Such embodiments can provide reduced latency. In some embodiments, the timing information may be transmitted as broadcast transmission. Such embodiments increase communications efficiency because a single transmission can transmit timing information to several sidelink communications devices. For example, a sidelink SIB adapted for transmission over a sidelink interface may be used to transmit the timing information. In some embodiments, the SIB comprising the timing information may be transmitted as a broadcast transmission. In some embodiments, the SIB comprising the timing information may be transmitted as a multi-cast transmission. For example, a group of sidelink communications devices (e.g. UE2 304, UE3 306, UE4 308) which are interested in timing information may be formed in advance by the wired network 310 or gNB. This group may be authorised by the core network. The SIB comprising timing information is then transmitted to the group of sidelink communications devices (for example, by UE1 302) by using either a multi-cast or broadcast transmission. Due to the LCP restrictions in MAC as explained above, a multi-cast or broadcast timing information transmission with a plurality of destination sidelink communications devices may be transmitted in a MAC TB which comprises 3 MAC PDUs. In some embodiments, where there is not enough room in a MAC TB for the MAC PDUs, then a second transmission of timing information comprising the remaining MAC PDUs may be transmitted. In such embodiments, the timing information in the first transmission and the timing information in the second transmission may be different because the MAC TB for the first transmission is transmitted at a different time than the MAC TB for the second transmission. As will be understood by one skilled in the art, a “multicast” transmission may also be referred to as a “groupcast” transmission.

The timing information indicates either a “referenced time” or a “non-referenced time”. The referenced time is an absolute time at UE1 302. The non-referenced time is the absolute time at the first sidelink communications device adjusted for propagation delay between UE1 302 and the UE which receives the timing information. As will be understood by a person skilled in the art, the propagation delay between two objects is the time taken for a wireless signal to propagate between the two objects. As will be understood by a person skilled in the art, adjusting or compensating the absolute time for propagation delay means adjusting the absolute time indicated by the timing information such that it is the absolute time at UE1 302 when the receiving UE receives the timing information.

In some embodiments, UE1 302 may transmit the timing information in a message (such as a MAC PDU) which also includes an identification of UE1 302 and an identification of the one or more UEs which are to receive the timing information. For example, the UE1 302 may include the identification of UE1 302 and the identification of UE2 304 in a message which includes timing information and transmit this message to UE2 304.

As mentioned above, timing information may be referenced (referred to as “Option 1”) or non-referenced (referred to as “Option 2”). Example scenarios of transmitting timing information according to Options 1 and 2 are illustrated in FIG. 7.

In the example shown in FIG. 7, in Option 1, a first step comprises UE1 302 transmitting referenced timing information to UE2 304. The referenced timing information indicates an absolute time at UE1 302. In Option 1, PDC is not performed in advance of the transmission of the referenced timing information.

In Option 2, step 1 comprises UE1 302 transmitting an rx-tx measurement configuration to UE2 304. Although not shown in FIG. 7, UE1 302 may then transmit a first reference signal to UE2 304 according to the rx-tx measurement configuration. In response, UE1 302 may receive a second reference signal from UE2 304 according to the rx-tx measurement configuration. The first and second reference signals may be S-SSB and/or SL-PRS for example. UE2 304 determines a time difference between reception of the first reference signal at UE2 304 and transmission of the second reference signal by UE2 304. Then, in step 2 shown in FIG. 7, UE2 304 transmits an indication of the time difference to UE1 302. In this case, in step 3, UE1 302 determines the propagation delay based on the time difference determined by UE2 304. In some embodiments, UE1 302 determines a time difference between transmission of the first reference signal to UE1 302 and reception of the second reference signal from UE2 304. In such embodiments, UE1 302 may determine the propagation delay based on the time difference determined by UE1 302 and the time difference determined by UE2 304.

After UE1 302 determines the propagation delay, it adjusts the timing information based on the determined propagation delay to form non-referenced timing information. In some embodiments, instead of steps 1 and 2, UE1 302 may determine the propagation delay by performing any of the methods described with reference to FIG. 9, 10, 12 or 13 below.

In step 4, UE1 302 transmits non-referenced timing information to UE2 304. Option 2 is particularly advantageous if timing information is transmitted using dedicated resources and/or as a unicast transmission.

After receiving the timing information from UE1 302, UE2 304 may synchronise with UE1 302 based on the timing information. For example, if the timing information indicates the non-referenced time, UE2 304 may adjust its clock such that it shows the time indicated by the timing information. In another example, if the timing information indicates the referenced time, then UE2 304 may subsequently determine a propagation delay between UE1 302 and UE2 304 (using any of the propagation delay compensation procedures discussed herein such as those explained with reference to FIG. 9, 10, 12 or 13 below), and adjust the indicated referenced time for propagation delay. Then UE2 304 adjusts its clock such that it shows the adjusted time.

In some embodiments, UE1 302 may transmit an indication to UE2 304 indicating whether the transmitted timing information is referenced or non-referenced. Therefore, UE2 304 can determine whether the time indicated in the timing information has already been compensated for propagation delay or not. In some embodiments, this indication is included in the same message in which the timing information is transmitted. In some embodiments, the UE2 304 is pre-configured to know whether the timing information transmitted by UE1 302 indicates a referenced or a non-referenced time because it is, for example, fixed in the specifications.

In some embodiments, an RLC UM/TM mode is configured for unicast, broadcast, or multicast transmission of the timing information. This reduces a transmission delay compared with, for example, an RLC-AM ARQ mode.

In some examples, the timing information transmitted by UE1 302 comprises a common referenced time for a plurality of UEs. For example, the timing information comprising the common referenced time may be transmitted to UE2 304 and one or more other UEs. In such examples, UE1 302 may also transmit an indication of a propagation delay between itself and UE2 304 to UE2 304, and UE1 may transmit an indication of a propagation delay between itself and the one or more other UEs to the one or more other UEs. Then, UE2 304 and each of the one or more other UEs adjusts the indicated common referenced time based on the indicated propagation delay. Then, UE2 304 and each of the one or more other UEs adjust their clock based on the adjusted common referenced time.

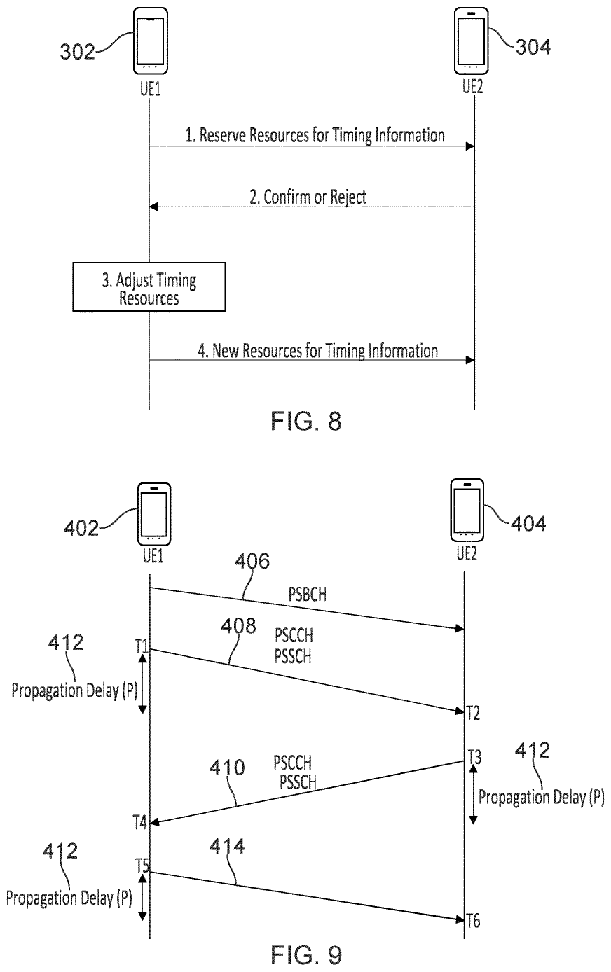

In some embodiments, sidelink communications devices co-ordinate to reserve resources for transmitting time information. The reserved resources are therefore dedicated for transmitting timing information. An example of such an embodiment is shown in FIG. 8. In step 1, UE1 302 transmits a resource reservation request to UE2 304 requesting to reserve resources for transmitting the timing information. In step 2, UE2 304 transmits a response to the resource reservation request to UE1 302. The response may indicate that the resource reservation request is accepted. In the case of acceptance, UE1 302 transmits the timing information in the reserved resources. In the case of rejection, the method proceeds to step 3. In step 3, UE1 302 determines new time resources for transmitting the timing information. Then, in step 4, UE1 302 transmits another resource reservation request to UE2 304 for reserving the new time resources. The procedure may continue until a resource reservation request is accepted by UE2 304. Embodiments which utilise resource reservation requests can improve communications efficiency by reducing a likelihood that the transmission of the timing information will collide with other transmissions. The procedure shown in FIG. 8 is an example of inter-UE co-ordination. Examples of conventional inter-UE co-ordination are described in the Annex.

### Sidelink Propagation Delay Measurement

In view of the above technical challenges, example embodiments can provide a method of operating a first sidelink communications device synchronised in time with a timing source. The method comprises transmitting a first measurement message to a second sidelink communications device via a sidelink interface. The method comprises receiving a second measurement message from the second sidelink communications device via the sidelink interface. The method comprises determining a time difference between a time, T1, at which the first measurement message is transmitted to the second sidelink communications device and a time, T4, at which the second measurement message is received by the first sidelink communications device. The method comprises determining a time difference between a time, T2, at which the second sidelink communications device receives the first measurement message and a time, T3, at which the second sidelink communications device transmits the second measurement message. The time difference between T2 and T3 is either pre-configured or the second measurement message comprises information for determining the time difference between T2 and T3. The method comprises determining a propagation delay between the first sidelink communications device and the second sidelink communications device based the time difference between T1 and T4 and the time difference between T2 and T3.

Reciprocal Messages with Timestamps

An example of sidelink propagation delay measurement using reciprocal messages with timestamps is shown in FIG. 9. FIG. 9 is a signal flow diagram illustrating communications between a first sidelink communications device (UE1 402) and a second sidelink communications device (UE2 404).

As shown in FIG. 9, UE1 402 broadcasts a physical sidelink broadcast channel (PSBCH) 406 to UE2 404. The PSBCH 406 comprises sidelink synchronisation signals (such as S-PSS and/or S-SSS) with a demodulation reference signal (DMRS). The PSBCH also comprises a direct frame number (DFN).

Then, the UE1 402 transmits a first measurement message 408 to UE2 404. The first measurement message 408 comprises a control channel (such as physical sidelink control channel (PSCCH)) and a data channel (such as a physical sidelink shared channel (PSSCH)). In some embodiments, the data channel may also carry additional control information (such as a HARQ enable indicator) because the capacity of the sidelink control channel may be limited. In some embodiments (not shown in FIG. 9), UE2 404 may transmit a request to UE1 402 to receive the first measurement message 408. A “measurement message” is a message used by a sidelink communications device to measure a time of transmission and/or reception of the measurement message.

The first measurement message 408 is transmitted by UE1 402 at a first time stamp, T1. The first measurement message 408 is received by UE2 404 at a second time stamp T2. The time difference between T1 and T2 is equal to a propagation delay (P) 412 between UE1 402 and UE2 404. In other words, P=T2−T1 (Equation 1).

Next, UE2 404 transmits a second measurement message 410 to UE1 402. The second measurement message 410 comprises a control channel (such as physical sidelink control channel (PSCCH)) and a data channel (such as a physical sidelink shared channel (PSSCH)). In some embodiments, the data channel may also carry additional control information (such as a HARQ enable indicator) because the capacity of the sidelink control channel may be limited.

The second measurement message 410 is transmitted by UE2 404 at a third time stamp, T3. The second measurement message 410 is received by UE1 402 at a fourth time stamp T4. The time difference between T4 and T3 is equal to the propagation delay (P) 412 between UE1 402 and UE2 404. In other words, P=T4−T3 (Equation 2). The second measurement message 410 comprises an indication of a time difference between time stamp T2 and time stamp T3 or an indication of time stamp T2 and T3.

UE1 402 then determines P 412 based on the time difference between T1 and T4, and the time difference between T2 and T3. For example, UE1 402 determines P 412 according to P=(T4−T1+T2−T3)/2 (Equation 3). Determining P 412 according to Equation 3 can provide an accurate value of P 412. In some embodiments, the propagation delay P 412 may be determined by UE2 404 in addition to, or instead of, UE1 402 determining the propagation delay 412. In such embodiments, the first measurement message 408 comprises an indication of T1. Furthermore, in such embodiments, a third measurement message 414 is transmitted by UE1 402 at time stamp T5, and is received by UE2 404 at time stamp T6. The third measurement message 414 may be any message which comprises an indication of time stamp T4. For example, the third measurement message 414 may or may not comprise a control channel (such as physical sidelink control channel (PSCCH)) and a data channel (such as a physical sidelink shared channel (PSSCH)). In some embodiments, the data channel may also carry additional control information (such as a HARQ enable indicator) because the capacity of the sidelink control channel may be limited. Therefore, UE2 calculates P 412 according to Equation 3.

In some embodiments, UE1 402 and UE2 404 do not move between T1 and T4. This means a more accurate value of P 412 can be obtained. UE1 402 and/or UE2 404 may check this condition in advance of the procedure shown in FIG. 9.

In some embodiments, UE1 402 may be synchronised with an accurate timing source in advance of the procedure shown in FIG. 9. UE1 402 may check this condition in advance of the procedure shown in FIG. 9. In such embodiments, the accuracy of the determined P 412 is improved because inaccuracy in synchronisation may cause time errors. The timing source may be a gNB, or another entity in the wireless communications network which maintains an accurate and stable clock. For example, UE1 402 may synchronise with the gNB when it is in coverage of the gNB. For example, UE1 402 may synchronise with the gNB by receiving one or more synchronisation signals (such as PSS/SSS) from the gNB. The gNB or other entity in the wireless communications network may already be synchronised with a TSN-GM or 5GM clock such as GNSS, an atomic clock, GPS time, or Coordinated Universal Time for example. In some cases, such as when the UE is out of coverage, the UE may synchronise directly with GNSS, an atomic clock, GPS time, or Coordinated Universal Time (UTC).

In some embodiments, UE2 404 is also synchronised with a timing source in advance of the procedure shown in FIG. 9. In such embodiments, UE1 402 may receive, from UE2 404, an indication of an accuracy of the timing source for UE2 404 and compare the accuracy of the timing source for UE1 402 with the accuracy of the timing source for UE2 404. Before commencing the procedure shown in FIG. 9, UE1 402 may determine that the accuracy of the timing source for UE1 402 is higher than the accuracy of the timing source for UE2 404. In some embodiments, UE1 402 may determine that the accuracy of the timing source for UE2 404 is higher than the accuracy of the timing source for UE1 402. In such embodiments, UE1 402 may inform UE2 406 of this. In such embodiments, the procedure in FIG. 9 is reversed such that steps performed by UE1 402 are performed by UE2 404 and vice versa.

### Sidelink HARQ Feedback

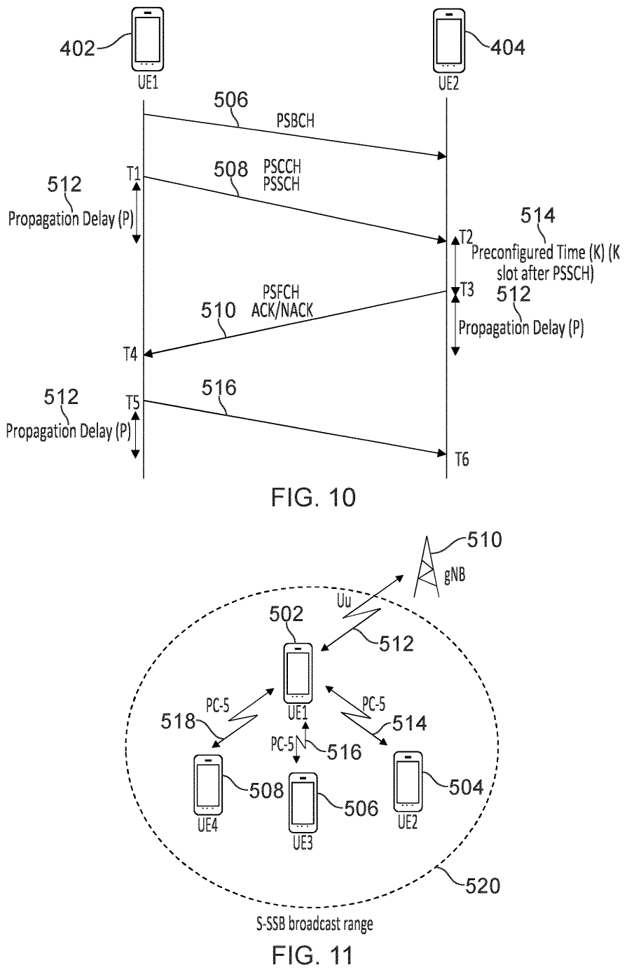

An example of propagation delay measurement using HARQ feedback is shown in FIG. 10. FIG. 10 illustrates communications between UE1 402 and UE2 404 in a unicast mode of operation. UE2 404 is enabled for HARQ feedback. Although multi-cast mode is also possible, unicast mode is particularly advantageous because it is easier for UE1 402 to determine which UE has transmitted HARQ feedback.

As shown in FIG. 10, UE1 402 broadcasts a physical sidelink broadcast channel (PSBCH) 506 to UE2 404. The PSBCH 506 comprises sidelink synchronisation signals (such as S-PSS and/or S-SSS) with a demodulation reference signal (DMRS). The PSBCH also comprises a direct frame number (DFN).

Then, UE1 402 transmits a first measurement message 408 to UE2 404. The first measurement message 408 comprises a control channel (such as physical sidelink control channel (PSCCH)) and a data channel (such as a physical sidelink shared channel (PSSCH)). In some embodiments (not shown in FIG. 10), UE2 404 may transmit a request to UE1 402 to receive the first measurement message 508.

The first measurement message 408 is transmitted by UE1 402 at a first time stamp, T1. The first measurement message 508 is received by UE2 404 at a second time stamp T2. The time difference between T1 and T2 is equal to a propagation delay (P) 512 between UE1 402 and UE2 404. In other words, P=T2−T1 (Equation 1).

Then, UE2 404 transmits a second measurement message 510 to UE1 402 at time stamp T3. The second measurement message 510 is transmitted a pre-configured time after UE2 404 receives the first measurement message 508. The pre-configured time is therefore a time difference between T2 and T3. For example, the second measurement message may be transmitted K slots after UE2 404 receives the first measurement message 508. The second measurement message 510 comprises HARQ feedback (e.g. ACK or NACK) in a feedback channel (such as physical sidelink feedback channel (PSFCH).

UE1 402 receives the second measurement message 510 at time stamp T4. Then, UE1 402 determines P 512 based on the time difference between T1 and T4 and the time difference between T2 and T3. For example, as will be understood from FIG. 10, T4=P+K+P+T1 (Equation 4). This is rearranged to P=(T4−T1−K)/2 (Equation 5). Therefore, UE1 402 may determine P 512 based on Equation 5.

In some embodiments, the propagation delay P 512 may be determined by UE2 404 in addition to, or instead of, UE1 402 determining the propagation delay 512. In such embodiments, the first measurement message 508 comprises an indication of T1. Furthermore, in such embodiments, a third measurement message 516 is transmitted by UE1 402 at time stamp T5, and is received by UE2 404 at time stamp T6. The third measurement message 414 may be any message which comprises an indication of time stamp T4. Therefore, UE2 calculates P 512 according to Equation 5.

In some embodiments, UE1 402 and UE2 404 do not move between T1 and T4. This means a more accurate value of P 512 can be obtained. UE1 402 and/or UE2 404 may check this condition in advance of the procedure shown in FIG. 10.

In some embodiments, UE1 402 may check that both UE1 402 UE2 404 support unicast mode in advance of the procedure shown in FIG. 10.

In some embodiments, UE1 402 enable HARQ feedback for UE2 404 in advance of the procedure shown in FIG. 10. For example, UE1 402 may transmit a HARQ enable indicator to UE2 404.

Rx-Tx Measurements with Sidelink Synchronization Signal/PBCH Block (S-SSB)

In view of the above technical challenges, example embodiments can provide a method of operating a second sidelink communications device. The method comprises receiving a first signal via a first sidelink interface from a first sidelink communications device synchronised in time with a timing source. The method comprises transmitting a second signal to a third sidelink communications device via a second sidelink interface. The method comprises receiving, from the third sidelink communications device via the second sidelink interface, a third signal. The first, second and third signals are different from each other. The method comprises determining a time difference between a time of arrival of the first signal from the first sidelink communications device and a time of arrival of the third signal from the third sidelink communications device at the second sidelink communications device. The method comprises receiving, from the third sidelink communications device via the second sidelink interface, information for determining a time difference between a time of arrival of the first signal and a time of arrival of the second signal at the third sidelink communications device. The method comprises determining the time difference between the time of arrival of the first signal and the time of arrival of the second signal at the third sidelink communications device based on the information received from the third sidelink communications device. The method comprises determining a propagation delay between the second sidelink communications device and the third sidelink communications device based on the time difference between the time of arrival of the first signal and the third signal at the second sidelink communications device and the time difference between the time of arrival of the first signal and the second signal at the third sidelink communications device.

FIG. 11 shows an example of calculating a propagation delay between sidelink communications devices using S-SSB. FIG. 11 illustrates a wireless communications network comprising a gNB 510 and a plurality of communications devices including a first sidelink communications device (UE1 502), a second sidelink communications device (UE2 504), a third sidelink communications device (UE1 506) and a fourth sidelink communications device (UE4 508). Although not shown in FIG. 11, the gNB 510 is connected to a core network. UE1 502 is synchronised with a timing source. The timing source may be the gNB 510 or other entity in the wireless communications network which maintains an accurate and stable clock. UE1 502 synchronises with the timing source 512 using conventional synchronisation methods such as by receiving timing information from the gNB as explained above. Since UE1 502 is already synchronised with a timing source, it may be the time reference among the plurality of sidelink communications devices shown in FIG. 11. UE1 502 may be referred to as a “SyncRef UE”.

As shown in FIG. 11, there is a Uu interface 512 between UE1 502 and the gNB 510, a sidelink interface between UE1 502 and UE2 504 (PC-5 514), a sidelink interface between UE1 502 and UE3 506 (PC-5 516) and a sidelink interface between UE1 502 and UE4 508 (PC-5 518). As shown in FIG. 11, UE1 502 can transmit S-SSB to sidelink communications devices which are within an S-SSS broadcast range 520. The sidelink communications devices within the S-SSB broadcast range 520 (other than UE1 502) use UE1 502 as a timing source. UE2 504, UE3 506 and UE4 508 may disable their own S-SSB transmissions to reduce power consumption and reduce interference with the S-SSB transmission of UE1 502.

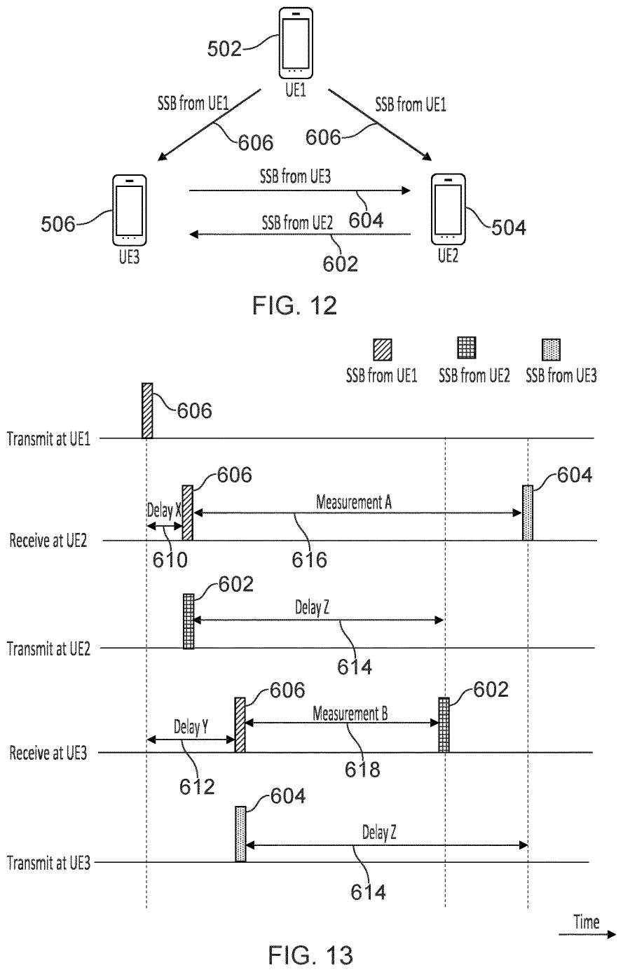

FIG. 12 illustrates S-SSB transmissions between sidelink communications devices for determining a propagation delay between UE2 and 504 and UE3 506. As shown in FIG. 12, UE1 502 broadcasts a first S-SSB 606 to UE2 504 and UE3 506. UE2 504 and UE3 506 use UE1 502 as a timing source by synchronising with UE1 502 using the first S-SSB 606. For example, the first S-SSB may comprise an SLSS ID and UE2 504 and UE3 506 may determine a priority level of UE1 502 as a timing source based on the SLSS ID in the first S-SSB 606. For example, an SLSS ID of between 336 and 671 may indicate that UE1 502 is a low accuracy timing source and therefore UE2 504 and UE3 506 determine not to use UE1 as a timing source. However, an SLSS ID of below 336 may indicate that UE1 502 is a high accuracy timing source and therefore UE2 504 and UE3 506 determine to synchronise with UE1 502 as the timing source.

After receiving the first S-SSB 606 from UE1 502, UE2 504 transmits a second S-SSB 602 to UE3 506. Similarly, after receiving the first S-SSB 606 from UE1 502, UE3 506 transmits a third S-SSB 604 to UE2 504. The first, second and third S-SSBs 606, 602, 604 are different so that neighbouring sidelink UEs do not mistakenly use them as a timing reference. For example, the sidelink sequence ID (SLSS ID) of the first, second and third S-SSBs 606, 602, 604 may be different.

FIG. 13 illustrates the transmission of S-SSBs and their corresponding propagation delays. As shown in FIG. 13, UE1 502 broadcasts the first S-SSB 606 to UE2 504 and UE3 506. The first S-SSB is received at UE2 504 after a propagation delay X 610 and the first S-SSB is received at UE3 506 after a propagation delay Y 612. After reception of the first S-SSB 606, UE2 504 transmits the second S-SSB 602 to UE3 506. UE3 506 receives the second S-SSB 602 after propagation delay Z 614. Similarly, after reception of the first S-SSB 606, UE3 506 transmits the third S-SSB 604 to UE2 504. UE2 504 receives the third S-SSB 604 after propagation delay Z 614.

UE2 504 determines a difference between a time of arrival of the first S-SSB 606 and the third S-SSB 604 (“Measurement Result A 616”). UE3 506 determines a difference between a time of arrival of the first S-SSB 606 and the second S-SSB 602 at UE3 506 (“Measurement Result B 618”).

UE2 504 transmits an indication of measurement result A 616 to UE3 506, and UE3 506 transmits an indication of measurement result B 618 to UE2 504. Therefore, both UE2 504 and UE3 506 are aware of measurement result A 616 and measurement result B 618.

As will be appreciated from FIG. 13, measurement result A=delay Y+delay Z−delay X (Equation 6) and Measurement result B=delay X+delay Z−delay Y (Equation 7). If these two equations are summed, the result is measurement result A+measurement result B=2*delay Z (Equation 8) which can be rearranged to delay Z=(measurement result A+measurement result B)/2 (Equation 9). Therefore, UE2 504 and UE3 506 each use Equation 9 to determine the propagation delay Z 614 which is the propagation delay between UE2 504 and UE3 506 as explained above.

The “S-SSBs” referred to in FIGS. 12 and 13 may alternatively be referred to as SL-SSBs. Alternatively, the S-SSBs may be replaced by SL-PRSs which are defined for positioning in Release-18 of the 3GPP standards. Alternatively, the SL-SBS may be replaced by CSI-RSs

Currently defined rx-ts measurements for Uu may be reused in sidelink PDC. For example, the accuracy and reporting values, as specified in TS 38.133 for Uu may be reused.

### Sidelink Timing Sensitivity Communication Assistance Information (TSCAI)

Example embodiments can provide a method of operating a second sidelink communications device. The method comprises receiving Time Sensitive Communication Assistance Information, TSCAI, from a first sidelink communications device via a sidelink interface The TSCAI information comprises one or more of a burst timing, periodicity and survival time. The method comprises performing resource allocation based on the received TSCAI.

TSCAI comprises information about traffic flow including one or more of a burst arrival time, burst periodicity, and survival time (the time which an application can survive without any burst (see TS 22.261)).

Conventionally, the direction of TSCAI is assumed to be either downlink or uplink. However, in accordance with example embodiments, a sidelink direction can be added. Therefore, when TSCAI is available at a gNB, the gNB may use the TSCAI information for sidelink configuration, resource allocation, and/or scheduling. The TSCAI may comprise an indication of a preferred channel or transmission interface such as PC5 (between UE and UE, i.e. sidelink) or Uu (between UE and gNB, i.e. normal air interface).

In accordance with example embodiments, when the sidelink is operated by gNB scheduling transmission (also known as “sidelink mode 1” in 3GPP), the gNB schedules the resources of sidelink in response to a scheduling request from UE. The gNB receives the TSCAI and if the direction is sidelink, other traffic parameters are taken into account in scheduler such as burst arrival time or survival time, periodicity to schedule the sidelink to meet requirements. For example, if periodic traffic is expected, the gNB configures mode 1 configure grant (CG) with periodic time slots in line with periodic traffic characteristics.

In accordance with example embodiments, when the sidelink is operated by UE autonomous transmission (also known as “sidelink mode 2” in 3GPP), the gNB allocates the resource pool of sidelink to UE. The gNB uses the information from TSCAI for resource pool allocation or sidelink configuration. For example, if the survival time is very short/critical (less than 2 seconds), gNB may allocate the separate (independent) resource pool to reduce/avoid the collisions other than the resource pool for normal traffic in order to meet the critical survival requirement. This is an improvement over conventional sidelink operation, which risks collision of sidelink transmissions because the resource pool is shared with multiple UEs and UE may transmit the sidelink anytime.

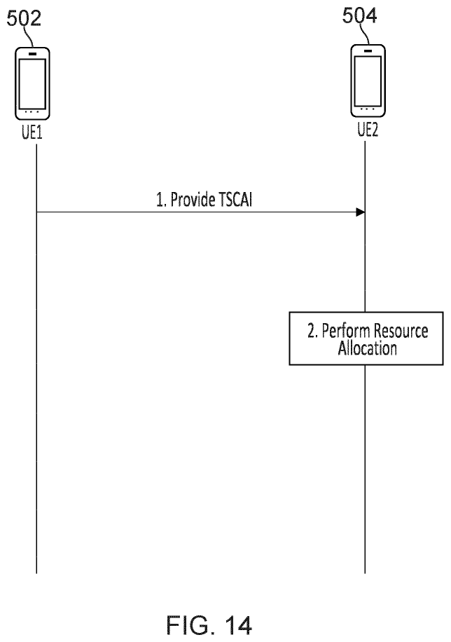

In accordance with example embodiments, TSCAI information may be transmitted over a sidelink interface to improve communications resource allocation for TSN. An example is shown in FIG. 14.

TSCAI may be readily available at UE1 502. For example, UE1 502 may receive the TSCAI from the gNB 510. In step 1, UE1 502 transmits the TSCAI to UE2 504. Then, in step 2, UE2 504 performs resource allocation based on the TSCAI. For example, UE2 504 may allocate or reallocate resources to prioritise reception of broadcasted timing information or other time sensitive information. Similarly, UE2 504 may allocate or reallocate resources to prioritise traffic transmission and/or reception over other tasks such as performing measurements or a SL-DRX off period. In some embodiments, UE1 502 may also perform resource allocation based on the TSCAI. In some embodiments, UE1 502 may use the resource in the separate resource pool for IIOT traffic. UE may be configured with configure grant (CG) by a gNB. It periodically sends the data in line with the periodic characteristics of traffic.

Although FIG. 14 has been described with reference to communications between UE1 502 and UE2 504, in other embodiments the steps performed by UE1 502 may be performed by UE2 504 and the steps performed by UE2 504 may be performed by UE3 506.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

Respective features of the present disclosure are defined by the following numbered paragraphs:
Paragraph 1. A method of operating a first sidelink communications device synchronised in time with a timing source, the method comprising
transmitting timing information to a second sidelink communications device via a sidelink interface, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device.
Paragraph 2. A method according to paragraph 1, comprising
transmitting, to the second communications device, an indication of whether the time comprised in the timing information is referenced time or non-referenced time.
Paragraph 3. A method according to paragraph 2, wherein the indication of whether the time comprised in the timing information is referenced time or non-referenced time is comprised in the timing information.
Paragraph 4. A method according to any of paragraphs 1 to 3, comprising
transmitting a resource reservation request to the second sidelink communications device, the resource reservation request indicating resources requested by the first sidelink communications device for transmitting the timing information,
receiving a response to the resource reservation request from the second sidelink communications device, the response indicating acceptance of the timing resource reservation request, wherein the timing information is transmitted in the resources indicated in the resource reservation request.
Paragraph 5. A method according to any of paragraphs 1 to 4, wherein the time indicated by the timing information is the non-referenced time and the method comprises, in advance of transmitting the timing information,
transmitting a reception-transmission, rx-tx, measurement configuration to the second sidelink communications device,
transmitting a first reference signal to the second sidelink communications device in accordance with the rx-tx measurement configuration,
receiving a second reference signal from the second sidelink communications device in accordance with the rx-tx measurement configuration,
receiving, from the second sidelink communications device, an indication of a time difference between reception of the first reference signal by the second sidelink communications device and transmission of the second sidelink reference signal by the second sidelink communications device,
determining the propagation delay between the first sidelink communications device and the second sidelink communications device based on the time difference indicated by the second sidelink communications device, and adjusting the absolute time at the first sidelink communications device based on the determined propagation delay.
Paragraph 6. A method according to paragraph 5, comprising
determining a time difference between transmission of the first reference signal to the second sidelink communications device and reception of the second reference signal from the second sidelink communications device, and
determining the propagation delay between the first sidelink communications device and the second sidelink communications device based on the time difference determined by the first sidelink communications device and the time difference indicated by the second sidelink communications device.
Paragraph 7. A method according to any of paragraphs 1 to 6, wherein the transmitting the timing information comprises broadcasting the timing information.
Paragraph 8. A method according to paragraph 7, wherein the broadcasting the timing information comprises broadcasting the timing information in a system information block, SIB.
Paragraph 9. A method according to any of paragraphs 1 to 6, wherein the transmitting the timing information comprises transmitting the timing information in a unicast transmission.
Paragraph 10. A method according to any of paragraphs 1 to 6, wherein the transmitting the timing information comprises transmitting the timing information to a group of sidelink communications devices including the second sidelink communications device in a multi-cast transmission.
Paragraph 11. A method according to any of paragraphs 1 to 10, wherein the first sidelink communications device is a relay communications device configured to relay signals between infrastructure equipment of a wireless communications network and the second sidelink communications device, wherein the timing source with which the first sidelink communications device is synchronised is the infrastructure equipment.
Paragraph 12. A method according to any of paragraphs 1 to 11, wherein the timing source with which the first sidelink communications device is synchronised is a 5G Grand Master clock (5G GM).
Paragraph 13. A method of operating a second sidelink communications device, the method comprising
receiving timing information from a first sidelink communications device via a sidelink interface, the first sidelink communications device being synchronised with a timing source, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device, and
synchronising with the first sidelink communications device based on the timing information.
Paragraph 14. A method according to paragraph 13, comprising
determining that the time comprised in the timing information is the referenced time based on a default setting in the absence of an indication from the first sidelink communications device of whether the time comprised in the timing information is the referenced time or the non-referenced time.
Paragraph 15. A method according to paragraph 13, comprising
receiving, from the first sidelink communications device, an indication of whether the time indicated by the timing information is the referenced time or the non-referenced time.
Paragraph 16. A method according to paragraph 15, wherein the indication of whether the time comprised in the timing information is the referenced time or the non-referenced time is comprised in the timing information.
Paragraph 17. A method according to any of paragraphs 13 to 16, comprising
receiving a resource reservation request from the first sidelink communications device, the resource reservation request indicating resources requested by the first sidelink communications device for transmitting the timing information,
transmitting a response to the resource reservation request to the first sidelink communications device, the response indicating acceptance of the timing resource reservation request, wherein the timing information is transmitted in the resources indicated in the resource reservation request.
Paragraph 18. A method according to any of paragraphs 13 to 16, wherein if the time indicated by the first sidelink communications device is the referenced time, the method comprises
determining a propagation delay between the first sidelink communications device and the second sidelink communication device, and
adjusting the referenced time for propagation delay between the first sidelink communications device and the second sidelink communications device.
Paragraph 19. A method according to any of paragraphs 13 to 16, wherein the time indicated by the timing information is the non-referenced time and the method comprises, in advance of receiving the timing information,
receiving a reception-transmission, rx-tx, measurement configuration from the first sidelink communications device,
receiving a first reference signal from the first sidelink communications device in accordance with the rx-tx measurement configuration,
transmitting a second reference signal to the first sidelink communications device in accordance with the rx-tx measurement configuration,
determining a time difference between the reception of the first reference signal from the first sidelink communications device and the transmission of the second reference signal to the first sidelink communications device,
transmitting an indication of the time difference to the first sidelink communications device.
Paragraph 20. A method of operating a first sidelink communications device synchronised in time with a timing source, the method comprising
transmitting a first measurement message to a second sidelink communications device via a sidelink interface,
receiving a second measurement message from the second sidelink communications device via the sidelink interface,
determining a time difference between a time, T1, at which the first measurement message is transmitted to the second sidelink communications device and a time, T4, at which the second measurement message is received by the first sidelink communications device,
determining a time difference between a time, T2, at which the second sidelink communications device receives the first measurement message and a time, T3, at which the second sidelink communications device transmits the second measurement message, wherein the time difference between T2 and T3 is either pre-configured or the second measurement message comprises information for determining the time difference between T2 and T3, and
determining a propagation delay between the first sidelink communications device and the second sidelink communications device based the time difference between T1 and T4 and the time difference between T2 and T3.
Paragraph 21. A method according to paragraph 20, wherein the second measurement message comprises information for determining time difference between T2 and T3, the information comprising either
an indication of the time difference between T2 and T3, or
an indication of T2 and T3.
Paragraph 22. A method according to paragraph 21, wherein the second message comprises a physical sidelink control channel, PSCCH, and a physical sidelink shared channel, PSSCH.
Paragraph 23. A method according to any of paragraphs 20 to 22, wherein the method comprises, in advance of the transmission of the first message,
determining an accuracy of the timing source with which the first sidelink communications device is synchronised,
determining an accuracy of a timing source with which the second sidelink communications device is synchronised, and
determining that the accuracy of the timing source with which the first sidelink communications device is synchronised is higher than the of the timing source with which the second sidelink communications device is synchronised.
Paragraph 24. A method according to any of paragraphs 20 to 23, wherein the time difference between T2 and T3 is pre-configured.
Paragraph 25. A method according to paragraph 24, wherein the second measurement message comprises hybrid automatic repeat request, HARQ, feedback in respect of the first measurement message.
Paragraph 26. A method according to any of paragraphs 20 to 25, wherein the first measurement message comprises a physical sidelink control channel, PSCCH, and a physical sidelink shared channel, PSSCH.
Paragraph 27. A method according to any of paragraphs 20 to 26, wherein the first sidelink communications device and the second sidelink communications device are stationary.
Paragraph 28. A method according to any of paragraphs 20 to 27, wherein the first sidelink communications device is a relay communications device configured to relay signals between infrastructure equipment of a wireless communications network and the second sidelink communications device, wherein the timing source with which the first sidelink communications device is synchronised is the infrastructure equipment.
Paragraph 29. A method according to any of paragraphs 20 to 28, wherein the timing source with which the first sidelink communications device is synchronised is a 5G Grand Master clock (5G GM).
Paragraph 30. A method according to any of paragraphs 20 to 29, wherein the first and second sidelink communications devices are in a unicast mode, and the method comprises determining that the first and second sidelink communications devices support the unicast mode.
Paragraph 31. A method of operating a second sidelink communications device, the method comprising
receiving a first signal via a first sidelink interface from a first sidelink communications device synchronised in time with a timing source,
transmitting a second signal to a third sidelink communications device via a second sidelink interface,
receiving, from the third sidelink communications device via the second sidelink interface, a third signal, the first, second and third signals being different from each other,
determining a time difference between a time of arrival of the first signal from the first sidelink communications device and a time of arrival of the third signal from the third sidelink communications device at the second sidelink communications device,
receiving, from the third sidelink communications device via the second sidelink interface, information for determining a time difference between a time of arrival of the first signal and a time of arrival of the second signal at the third sidelink communications device,
determining the time difference between the time of arrival of the first signal and the time of arrival of the second signal at the third sidelink communications device based on the information received from the third sidelink communications device, and
determining a propagation delay between the second sidelink communications device and the third sidelink communications device based on the time difference between the time of arrival of the first signal and the third signal at the second sidelink communications device and the time difference between the time of arrival of the first signal and the second signal at the third sidelink communications device.
Paragraph 32. A method according to paragraph 31, wherein the first, second and third signals are first, second and third sidelink synchronisation signal blocks, S-SSBs, respectively.
Paragraph 33. A method according to paragraph 32, wherein a sidelink sequence ID, SLSS-ID, for each of the first, second and third SSBs is different.
Paragraph 34. A method according to paragraph 31, wherein the first, second and third signals are first, second and third sidelink positioning reference signals, S-PRSs, respectively.
Paragraph 35. A method of operating a first sidelink communications device, the method comprising
transmitting Time Sensitive Communication Assistance Information, TSCAI, to a second sidelink communications device via a sidelink interface, wherein the TSCAI information comprises one or more of a burst timing, burst periodicity and survival time.
Paragraph 36. A method according to paragraph 35, wherein the first sidelink communications device is a relay communications device configured to relay signals between infrastructure equipment of a wireless communications network and the second sidelink communications device, the method comprising
receiving the TSCAI from the infrastructure equipment.
Paragraph 37. A method of operating a second sidelink communications device, the method comprising
receiving Time Sensitive Communication Assistance Information, TSCAI, from a first sidelink communications device via a sidelink interface, wherein the TSCAI information comprises one or more of a burst timing, periodicity and survival time, and
performing resource allocation based on the received TSCAI.
Paragraph 38. A method according to paragraph 37, comprising
prioritising transmission or reception based on the TSCAI information.
Paragraph 39. A first sidelink communications device synchronised in time with a timing source, the first sidelink communications device comprising
a transmitter configured to transmit signals,
a receiver configured to receive signals,
a controller configured in combination with the transmitter and the receiver to
transmit timing information to a second sidelink communications device via a sidelink interface, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device.
Paragraph 40. A second sidelink communications device, the second sidelink communications device comprising
a transmitter configured to transmit signals,
a receiver configured to receive signals,
a controller configured in combination with the transmitter and the receiver to
receive timing information from a first sidelink communications device via a sidelink interface, the first sidelink communications device being synchronised with a timing source, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device, and
synchronising with the first sidelink communications device based on the timing information.
Paragraph 41. A first sidelink communications device synchronised in time with a timing source, the first sidelink communications device comprising
a transmitter configured to transmit signals,
a receiver configured to receive signals,
a controller configured in combination with the transmitter and the receiver to
transmit a first measurement message to a second sidelink communications device via a sidelink interface,
receive a second measurement message from the second sidelink communications device via the sidelink interface,
determine a time difference between a time, T1, at which the first measurement message is transmitted to the second sidelink communications device and a time, T4, at which the second measurement message is received by the first sidelink communications device,
determine a time difference between a time, T2, at which the second sidelink communications device receives the first measurement message and a time, T3, at which the second sidelink communications device transmits the second measurement message, wherein the time difference between T2 and T3 is either pre-configured or the second measurement message comprises information for determining the time difference between T2 and T3, and
determine a propagation delay between the first sidelink communications device and the second sidelink communications device based the time difference between T1 and T4 and the time difference between T2 and T3.
Paragraph 42. A second sidelink communications device, the second sidelink communications device comprising
a transmitter configured to transmit signals,
a receiver configured to receive signals,
a controller configured in combination with the transmitter and the receiver to
receive a first signal via a first sidelink interface from a first sidelink communications device synchronised in time with a timing source,
transmit a second signal to a third sidelink communications device via a second sidelink interface,
receive, from the third sidelink communications device via the second sidelink interface, a third signal, the first, second and third signals being different from each other,
determine a time difference between a time of arrival of the first signal from the first sidelink communications device and a time of arrival of the third signal from the third sidelink communications device at the second sidelink communications device,
receive, from the third sidelink communications device via the second sidelink interface, information for determining a time difference between a time of arrival of the first signal and a time of arrival of the second signal at the third sidelink communications device,
determine the time difference between the time of arrival of the first signal and the time of arrival of the second signal at the third sidelink communications device based on the information received from the third sidelink communications device, and
determine a propagation delay between the second sidelink communications device and the third sidelink communications device based on the time difference between the time of arrival of the first signal and the third signal at the second sidelink communications device and the time difference between the time of arrival of the first signal and the second signal at the third sidelink communications device.
Paragraph 43. A first sidelink communications device, the first sidelink communications device comprising
a transmitter configured to transmit signals,
a receiver configured to receive signals,
a controller configured in combination with the transmitter and the receiver to
transmit Time Sensitive Communication Assistance Information, TSCAI, to a second sidelink communications device via a sidelink interface, wherein the TSCAI information comprises one or more of a burst timing, burst periodicity and survival time.
Paragraph 44. A second sidelink communications device, the second sidelink communications device comprising
a transmitter configured to transmit signals,
a receiver configured to receive signals,
a controller configured in combination with the transmitter and the receiver to
receive Time Sensitive Communication Assistance Information, TSCAI, from a first sidelink communications device via a sidelink interface, wherein the TSCAI information comprises one or more of a burst timing, periodicity and survival time, and
perform resource allocation based on the received TSCAI.
Paragraph 45. Circuitry for a first sidelink communications device synchronised in time with a timing source, the circuitry comprising
transmitter circuitry configured to transmit signals,
receiver circuitry configured to receive signals,
controller circuitry configured in combination with the transmitter circuitry and the receiver circuitry to
transmit timing information to a second sidelink communications device via a sidelink interface, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device.
Paragraph 46. Circuitry for a second sidelink communications device, the circuitry comprising
transmitter circuitry configured to transmit signals,
receiver circuitry configured to receive signals,
controller circuitry configured in combination with the transmitter circuitry and the receiver circuitry to
receive timing information from a first sidelink communications device via a sidelink interface, the first sidelink communications device being synchronised with a timing source, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device, and
synchronising with the first sidelink communications device based on the timing information.
Paragraph 47. Circuitry for a first sidelink communications device synchronised in time with a timing source, the circuitry comprising
a transmitter configured to transmit signals,
a receiver configured to receive signals,
a controller configured in combination with the transmitter and the receiver to
transmit a first measurement message to a second sidelink communications device via a sidelink interface,
receive a second measurement message from the second sidelink communications device via the sidelink interface,
determine a time difference between a time, T1, at which the first measurement message is transmitted to the second sidelink communications device and a time, T4, at which the second measurement message is received by the first sidelink communications device,
determine a time difference between a time, T2, at which the second sidelink communications device receives the first measurement message and a time, T3, at which the second sidelink communications device transmits the second measurement message, wherein the time difference between T2 and T3 is either pre-configured or the second measurement message comprises information for determining the time difference between T2 and T3, and
determine a propagation delay between the first sidelink communications device and the second sidelink communications device based the time difference between T1 and T4 and the time difference between T2 and T3.
Paragraph 48. Circuitry for a second sidelink communications device, the circuitry comprising
transmitter circuitry configured to transmit signals,
receiver circuitry configured to receive signals,
controller circuitry configured in combination with the transmitter circuitry and the receiver circuitry to
receive a first signal via a first sidelink interface from a first sidelink communications device synchronised in time with a timing source,
transmit a second signal to a third sidelink communications device via a second sidelink interface,
receive, from the third sidelink communications device via the second sidelink interface, a third signal, the first, second and third signals being different from each other,
determine a time difference between a time of arrival of the first signal from the first sidelink communications device and a time of arrival of the third signal from the third sidelink communications device at the second sidelink communications device,
receive, from the third sidelink communications device via the second sidelink interface, information for determining a time difference between a time of arrival of the first signal and a time of arrival of the second signal at the third sidelink communications device,
determine the time difference between the time of arrival of the first signal and the time of arrival of the second signal at the third sidelink communications device based on the information received from the third sidelink communications device, and
determine a propagation delay between the second sidelink communications device and the third sidelink communications device based on the time difference between the time of arrival of the first signal and the third signal at the second sidelink communications device and the time difference between the time of arrival of the first signal and the second signal at the third sidelink communications device.
Paragraph 49. Circuitry for a first sidelink communications device, the circuitry comprising
transmitter circuitry configured to transmit signals,
receiver circuitry configured to receive signals,
controller circuitry configured in combination with the transmitter circuitry and the receiver circuitry to
transmit Time Sensitive Communication Assistance Information, TSCAI, to a second sidelink communications device via a sidelink interface, wherein the TSCAI information comprises one or more of a burst timing, burst periodicity and survival time.
Paragraph 50. Circuitry for a second sidelink communications device, the circuitry comprising
transmitter circuitry configured to transmit signals,
receiver circuitry configured to receive signals,
controller circuitry configured in combination with the transmitter circuitry and the receiver circuitry to
receive Time Sensitive Communication Assistance Information, TSCAI, from a first sidelink communications device via a sidelink interface, wherein the TSCAI information comprises one or more of a burst timing, periodicity and survival time, and
perform resource allocation based on the received TSCAI.
Paragraph 51. A computer program comprising instructions which, when loaded onto a computed, cause the computer to perform the method of any of paragraphs 1 to 38.
Paragraph 52. A non-transitory computer-readable storage medium storing a computer program according to paragraph 51.

Further particular and preferred aspects of the present invention are set out in the accompanying independent and dependent claims. It will be appreciated that features of the dependent claims may be combined with features of the independent claims in combinations other than those explicitly set out in the claims.

### ANNEX

### DLInformationTransfer

The DLInformationTransfer message is used for the downlink transfer of NAS dedicated information, timing information for the 5G internal system clock, or IAB-DU specific F1-C related information.

The network may configure the UE to report the following Rx-Tx time difference measurement information based on CSI-RS for tracking or PRS:
UE Rx-Tx time difference measurement result.

The network may configure the UE to perform the following types of measurements for NR sidelink and V2X sidelink:
CBR measurements.

$$SL - TypeTxSync - r 16 : := \qquad ENUMERATED \{ gnss , gnbEnb , ue \}$$

### SL-SyncConfig

The IE SL-SyncConfig specifies the configuration information concerning reception of synchronisation signals from neighbouring cells as well as concerning the transmission of synchronisation signals for sidelink communication. The SL-SyncConfig information element is shown below.

### SL-SyncConfig Information Element

| -- ASN1START | |
|---|---|
| -- TAG-SL-SYNCCONFIG-START | |
| SL-SyncConfigList-r16 ::= | SEQUENCE (SIZE (1..maxSL- |
| SyncConfig-r16)) OF SL-SyncConfig-r16 | |
| SL-SyncConfig-r16 ::= | SEQUENCE { |
| sl-SyncRefMinHyst-r16 | ENUMERATED {dB0, dB3, dB6, dB9 |
| dB12} | OPTIONAL, -- Need R |
| sl-SyncRefDiffHyst-r16 | ENUMERATED {dB0, dB3, dB6, dB9, |
| dB12, dBinf} | OPTIONAL, -- Need R |
| sl-filterCoefficient-r16 | FilterCoefficient |
| OPTIONAL, -- Need R | |
| sl-SSB-TimeAllocation1-r16 | SL-SSB-TimeAllocation-r16 |
| OPTIONAL, -- Need R | |
| sl-SSB-TimeAllocation2-r16 | SL-SSB-TimeAllocation-r16 |
| OPTIONAL, -- Need R | |
| sl-SSB-TimeAllocation3-r16 | SL-SSB-TimeAllocation-r16 |
| OPTIONAL, -- Need R | |
| sl-SSID-r16 | INTEGER (0..671) |
| OPTIONAL, -- Need R | |
| txParameters-r16 | SEQUENCE { |
| syncTxThreshIC-r16 | SL-RSRP-Range-r16 |
| OPTIONAL, -- Need R | |
| syncTxThreshOoC-r16 | SL-RSRP-Range-r16 |
| OPTIONAL, -- Need R | |
| syncInfoReserved-r16 | BIT STRING (SIZE (2)) |
| OPTIONAL -- Need R | |
| }, | |
| gnss-Sync-r16 | ENUMERATED {true} |
| OPTIONAL, -- Need R | |
| ... | |
| } | |
| SL-RSRP-Range-r16 ::= | INTEGER (0..13) |
| SL-SSB-TimeAllocation-r16 ::= | SEQUENCE { |
| sl-NumSSB-WithinPeriod-r16 | ENUMERATED {n1, n2, n4, n8, |
| n16, n32, n64} | OPTIONAL, -- Need R |
| sl-TimeOffsetSSB-r16 | INTEGER (0..1279) |
| OPTIONAL, -- Need R | |
| sl-TimeInterval-r16 | INTEGER (0..639) |

OPTIONAL -- Need R
}
-- TAG-SL-SYNCCONFIG-STOP
-- ASN1STOP

The field descriptions of the SL-SyncConfi information element are shown in Table 2.

TABLE 2
SL-SyncConfig field descriptions

gnss-Sync
If configured, the synchronization configuration is used for SLSS transmission/reception when the UE is
synchronized to GNSS. If not configured, the synchronization configuration is used for SLSS
transmission/reception when the UE is synchronized to eNB/gNB.
sl-SyncRefMinHyst
Hysteresis when evaluating a SyncRef UE using absolute comparison.
sl-SyncRefDiffHyst
Hysteresis when evaluating a SyncRef UE using relative comparison.
sl-NumSSB-WithinPeriod
Indicates the number of sidelink SSB transmissions within one sidelink SSB period. The applicable values are
related to the subcarrier spacing and frequency as follows:
FR1, SCS = 15 kHz: 1
FR1, SCS = 30 kHz: 1, 2
FR1, SCS = 60 kHz: 1, 2, 4
FR2, SCS = 60 kHz: 1, 2, 4, 8, 16, 32
FR2, SCS = 120 kHz: 1, 2, 4, 8, 16, 32, 64
sl-TimeOffsetSSB
Indicates the slot offset from the start of sidelink SSB period to the first sidelink SSB.
sl-TimeInterval
Indicates the slot interval between neighboring sidelink SSBs. This value is applicable when there are more
than one sidelink SSBs within one sidelink SSB period.
sl-SSID
Indicates the ID of sidelink synchronization signal associated with different synchronization priorities.
syncInfoReserved
Reserved for future use.
syncTxThreshIC, syncTxThreshOoC
Indicates the thresholds used while in coverage and out of coverage, respectively. Value 0 corresponds to
−infinity, value 1 to −115 dBm, value 2 to −110 dBm, and so on (i.e. in steps of 5 dBm) until value 12, which
corresponds to −60 dBm, while value 13 corresponds to +infinity.

### Inter-UE Co-ordination (IUC)

As will be known to a person skilled in the art, inter-UE co-ordination (IUC) refers to sidelink communications between communications devices for the purposes of co-ordinating the communications devices. The following schemes of inter-UE coordination are currently supported:
IUC scheme 1, IUC information is sent from a UE-A to a UE-B indicating preferred or non-preferred resources for a transmission by UE-B, and
IUC scheme 2, IUC information is sent from a UE-A to a UE-B indicates the presence of expected/potential resource conflict on resources indicated by UE-B's SCI.

In scheme 1, the transmission of IUC information from UE-A can be triggered by an explicit request from UE-B, or by a condition at UE-A. UE-A determines the set of resources reserved by other UEs or slots where UE-A, when it is the intended receiver of UE-B, does not expect to perform SL reception from UE-B due to half-duplex operation. UE-A uses these resources as the set of non-preferred resources, or excludes these resources to determine a set of preferred resources and sends the preferred/non-preferred resources to UE-B. UE-B's resources for resource (re) selection can be based on both UE-B's sensing results (if available) and the IUC information received from UE-A, or it can be based only on IUC information received from UE-A. For scheme 1, MAC CE and second-stage SCI or MAC CE only can be used to send IUC information. For transmission of the explicit request and reporting for IUC information in unicast manner is supported.

In scheme 2, UE-A determines the expected/potential resource conflict within the resources indicated by UE-B's SCI as either resources reserved by other UEs and identified by UE-A as fully/partially overlapping with the resources indicated by UE-B's SCI, or as slots where UE-A is the intended receiver of UE-B and does not expect to perform SL reception on those slots due to half-duplex operation. UE-B uses the conflicting resources to determine the resources to be reselected and exclude the conflicting resources from the reselected resources. For scheme 2, PSFCH is used to send IUC information.

### REFERENCES

[1] Holma H. and Toskala A, “LTE for UMTS OFDMA and SC-FDMA based radio access”, John Wiley and Sons, 2009.
[2] TR 38.913, “3^{rd} Generation Partnership Project; Technical Specification Group Radio Access Network; Study on Scenarios and Requirements for Next Generation Access Technologies (Release 14)”, 3GPP, v14.3.0, August 2017.
[3] TS 38.470, 3^{rd} Generation Partnership Project; Technical Specification Group Radio Access Network; NG-RAN; F1 general aspects and principles (Release 17) “, 3GPP, v17.2.0, September 2022.
[4] TS 38.473, 3^{rd} Generation Partnership Project; Technical Specification Group Radio Access Network; NG-RAN; F1 application protocol (F1AP) (Release 17)”, 3GPP, v17.2.0, September 2022.

1. A method of operating a first sidelink communications device synchronised in time with a timing source, the method comprising
transmitting timing information to a second sidelink communications device via a sidelink interface, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device.

2. A method according to claim 1, comprising
transmitting, to the second communications device, an indication of whether the time comprised in the timing information is referenced time or non-referenced time.

3. A method according to claim 2, wherein the indication of whether the time comprised in the timing information is referenced time or non-referenced time is comprised in the timing information.

4. A method according to claim 1, comprising
transmitting a resource reservation request to the second sidelink communications device, the resource reservation request indicating resources requested by the first sidelink communications device for transmitting the timing information,
receiving a response to the resource reservation request from the second sidelink communications device, the response indicating acceptance of the timing resource reservation request, wherein the timing information is transmitted in the resources indicated in the resource reservation request.

5. A method according to claim 1, wherein the time indicated by the timing information is the non-referenced time and the method comprises, in advance of transmitting the timing information,
transmitting a reception-transmission, rx-tx, measurement configuration to the second sidelink communications device,
transmitting a first reference signal to the second sidelink communications device in accordance with the rx-tx measurement configuration,
receiving a second reference signal from the second sidelink communications device in accordance with the rx-tx measurement configuration,
receiving, from the second sidelink communications device, an indication of a time difference between reception of the first reference signal by the second sidelink communications device and transmission of the second sidelink reference signal by the second sidelink communications device,
determining the propagation delay between the first sidelink communications device and the second sidelink communications device based on the time difference indicated by the second sidelink communications device, and
adjusting the absolute time at the first sidelink communications device based on the determined propagation delay.

6. A method according to claim 5, comprising
determining a time difference between transmission of the first reference signal to the second sidelink communications device and reception of the second reference signal from the second sidelink communications device, and
determining the propagation delay between the first sidelink communications device and the second sidelink communications device based on the time difference determined by the first sidelink communications device and the time difference indicated by the second sidelink communications device.

7. A method according to claim 1, wherein the transmitting the timing information comprises broadcasting the timing information.

8. A method according to claim 7, wherein the broadcasting the timing information comprises broadcasting the timing information in a system information block, SIB.

9. A method according to claim 1, wherein the transmitting the timing information comprises transmitting the timing information in a unicast transmission.

10. A method according to claim 1, wherein the transmitting the timing information comprises transmitting the timing information to a group of sidelink communications devices including the second sidelink communications device in a multi-cast transmission.

11. A method according to claim 1, wherein the first sidelink communications device is a relay communications device configured to relay signals between infrastructure equipment of a wireless communications network and the second sidelink communications device, wherein the timing source with which the first sidelink communications device is synchronised is the infrastructure equipment.

12. A method according to claim 1, wherein the timing source with which the first sidelink communications device is synchronised is a 5G Grand Master clock (5G GM).

13.-38. (canceled)

39. A first sidelink communications device synchronised in time with a timing source, the first sidelink communications device comprising
a transmitter configured to transmit signals,
a receiver configured to receive signals,
a controller configured in combination with the transmitter and the receiver to
transmit timing information to a second sidelink communications device via a sidelink interface, wherein the timing information comprises either
a referenced time, the referenced time being an absolute time at the first sidelink communications device, or
a non-referenced time, the non-referenced time being the absolute time at the first sidelink communications device adjusted for propagation delay between the first sidelink communications device and the second sidelink communications device.

40.-42. (canceled)

43. A first sidelink communications device, the first sidelink communications device comprising
a transmitter configured to transmit signals,
a receiver configured to receive signals,
a controller configured in combination with the transmitter and the receiver to
transmit Time Sensitive Communication Assistance Information, TSCAI, to a second sidelink communications device via a sidelink interface, wherein the TSCAI information comprises one or more of a burst timing, burst periodicity and survival time.

44.-52. (canceled)
